(19) United States
(12) Patent Application Publication
(10) Pub. No.: US 2019/0179350 A1
(43) Pub. Date: Jun. 13, 2019

(54) DISHWASHER APPLIANCE HAVING A PRESSURE SENSOR

(71) Applicant: Haier US Appliance Solutions, Inc., Wilmington, DE (US)

(72) Inventor: Kyle Edward Durham, Louisville, KY (US)

(21) Appl. No.: 15/834,229

(22) Filed: Dec. 7, 2017

(51) Int. Cl. G05D 16/20; A47L 15/00; A47L 15/42; G05B 19/042

(52) U.S. Cl. CPC G05D 16/2066; A47L 15/0052; A47L 15/4244; A47L 15/4221; G05D 16/2013; G05B 2219/2613; A47L 2401/14; A47L 2401/09; A47L 2401/20; A47L 2501/05; G05B 19/042

(57) ABSTRACT

A dishwasher appliance includes a circulation pump, a pressure sensor upstream of the circulation pump, and a diverter downstream of the circulation pump. A method of circulating fluid includes operating the circulation pump at a first speed less than a target speed for a first amount of time. The method also includes determining a first minimum pressure value based on the first speed and a position of the diverter and monitoring a pressure upstream of the circulation pump with the pressure sensor. The method further includes operating the circulation pump at a second speed greater than the first speed when the monitored pressure continuously exceeds the first minimum pressure value for a second amount of time and determining a second minimum pressure value based on the second speed and the position of the diverter after operating the circulation pump at the second speed for a third amount of time.

### FIELD OF THE INVENTION

The present disclosure relates generally to dishwasher appliances, and more particularly to dishwasher appliances having features and methods for ensuring optimal fill levels.

### BACKGROUND OF THE INVENTION

Dishwasher appliances generally include a tub that defines a wash chamber. Rack assemblies can be mounted within the wash chamber of the tub for receipt of articles for washing. Multiple spray assemblies can be positioned within the wash chamber for applying or directing wash fluid towards articles disposed within the rack assemblies in order to clean such articles. Dishwasher appliances are also typically equipped with at least one circulation pump for circulating fluid through the wash chamber, e.g., via one or more of the multiple spray assemblies, for washing or rinsing items contained in the wash chamber. For example, liquid can collect in a sump disposed at a bottom of the wash chamber during operation of the dishwasher appliance and the circulation pump can be operated to urge such liquid from the sump to selected spray assemblies.

In general, it is considered desirable for a dishwasher appliance to operate quietly. The noise level generated by the circulation pump is critical to such quiet operation. However, an undesirably high noise level may be generated if air is drawn into the circulation pump and becomes entrained in the circulated liquid. Air may be drawn into the circulation pump, for example, when the circulation pump operates at a speed that is too high relative to the rate of flow into the sump such that the liquid level in the sump is drawn down too low relative to the inlet of the circulation pump. It is also considered desirable for a dishwasher appliance to operate efficiently, for example, by using the least amount of water necessary to prime the circulation pump during the cleaning operation. Typical dishwasher appliances, however, are often configured to avoid entraining air by drawing additional water above the minimum amount required to prime the circulation pump.

Accordingly, dishwasher appliances that include features and methods for operating the circulation pump at an optimal speed and thereby ensuring optimal fill levels would be useful.

### BRIEF DESCRIPTION OF THE INVENTION

The present disclosure provides a dishwasher appliance that includes features and methods for avoiding or minimizing air entrainment in the circulation pump without overfilling the sump. Additional aspects and advantages of the invention will be set forth in part in the following description, may be apparent from the description, or may be learned through practice of the invention.

In accordance with one exemplary embodiment, a method of circulating fluid in a dishwasher appliance is provided. The dishwasher appliance includes a circulation pump, a pressure sensor upstream of the circulation pump, and a diverter downstream of the circulation pump. The method includes operating the circulation pump at a first speed less than a target speed for a first amount of time. The method also includes determining a first minimum pressure value based on the first speed and a position of the diverter and monitoring a pressure upstream of the circulation pump with the pressure sensor. The method further includes operating the circulation pump at a second speed greater than the first speed when the monitored pressure continuously exceeds the first minimum pressure value for a second amount of time. The method also includes determining a second minimum pressure value based on the second speed and the position of the diverter after operating the circulation pump at the second speed for a third amount of time.

In accordance with another exemplary embodiment, a dishwasher appliance is provided. The dishwasher appliance includes a cabinet with a tub positioned within the cabinet. The tub defines a wash chamber for receipt of articles for washing. The dishwasher appliance also includes one or more spray assemblies and a circulation pump for circulating water to the one or more spray arm assemblies. A pressure sensor is upstream of the circulation pump and a diverter is downstream of the circulation pump. The dishwasher appliance also includes a controller communicatively coupled with the pressure sensor and the circulation pump. The controller is configured to operate the circulation pump at a first speed less than a target speed for a first amount of time, determine a first minimum pressure value based on the first speed and a position of the diverter, and monitor a pressure upstream of the circulation pump with the pressure sensor. The controller is also configured to operate the circulation pump at a second speed greater than the first speed when the monitored pressure continuously exceeds the first minimum pressure value for a second amount of time and determine a second minimum pressure value based on the second speed and the position of the diverter after operating the circulation pump at the second speed for a third amount of time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary embodiment of a dishwasher appliance of the present disclosure with a door in a partially open position.

FIG. 2 provides a side, cross sectional view of the exemplary dishwasher appliance of FIG. 1.

FIG. 3 provides a cross sectional view of a circulation pump, a sump, and a pressure sensor of the dishwasher appliance of FIGS. 1 and 2.

FIG. 4 provides an enlarged view of a portion of FIG. 3.

FIG. 5 provides a flow diagram of an exemplary method according to one or more exemplary embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to, but need not be limited to dishes, pots, pans, silverware, and other cooking utensils and items that can be cleaned in a dishwashing appliance. The term “wash cycle” is intended to refer to one or more periods of time during which a dishwashing appliance operates while containing the articles to be washed and uses a detergent and water, preferably with agitation, to e.g., remove soil particles including food and other undesirable elements from the articles. The term “rinse cycle” is intended to refer to one or more periods of time during which the dishwashing appliance operates to remove residual soil, detergents, and other undesirable elements that were retained by the articles after completion of the wash cycle. The term “drain cycle” is intended to refer to one or more periods of time during which the dishwashing appliance operates to discharge soiled water from the dishwashing appliance. The term “wash fluid” refers to a liquid used for washing and/or rinsing the articles and is typically made up of water that may include other additives such as detergent or other treatments. Furthermore, as used herein, terms of approximation, such as “approximately,” “substantially,” or “about,” refer to being within a ten percent (10%) margin of error.

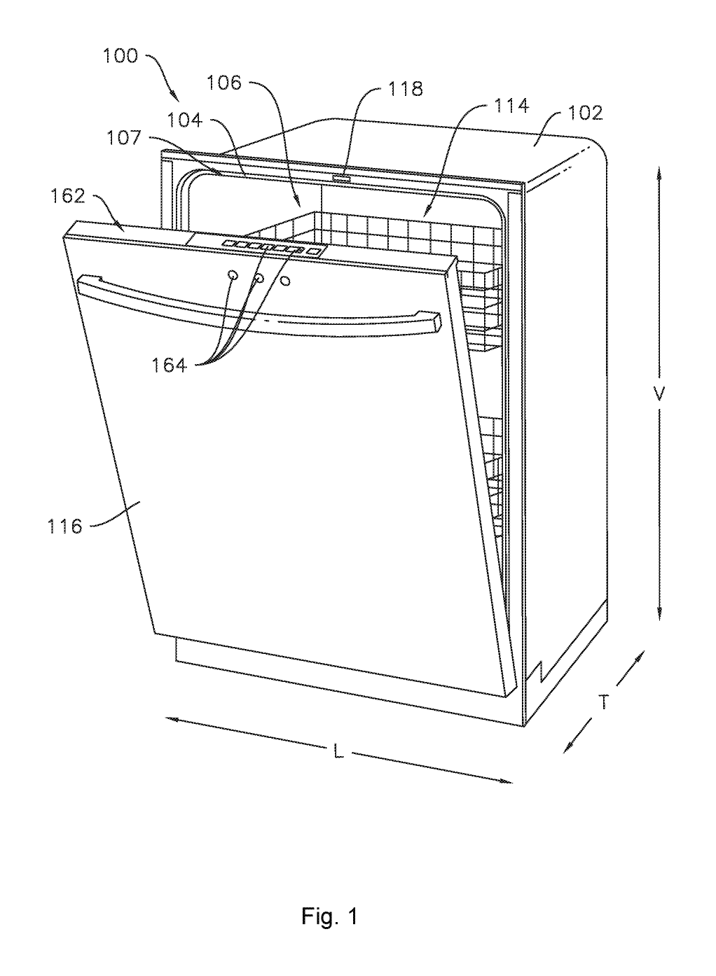

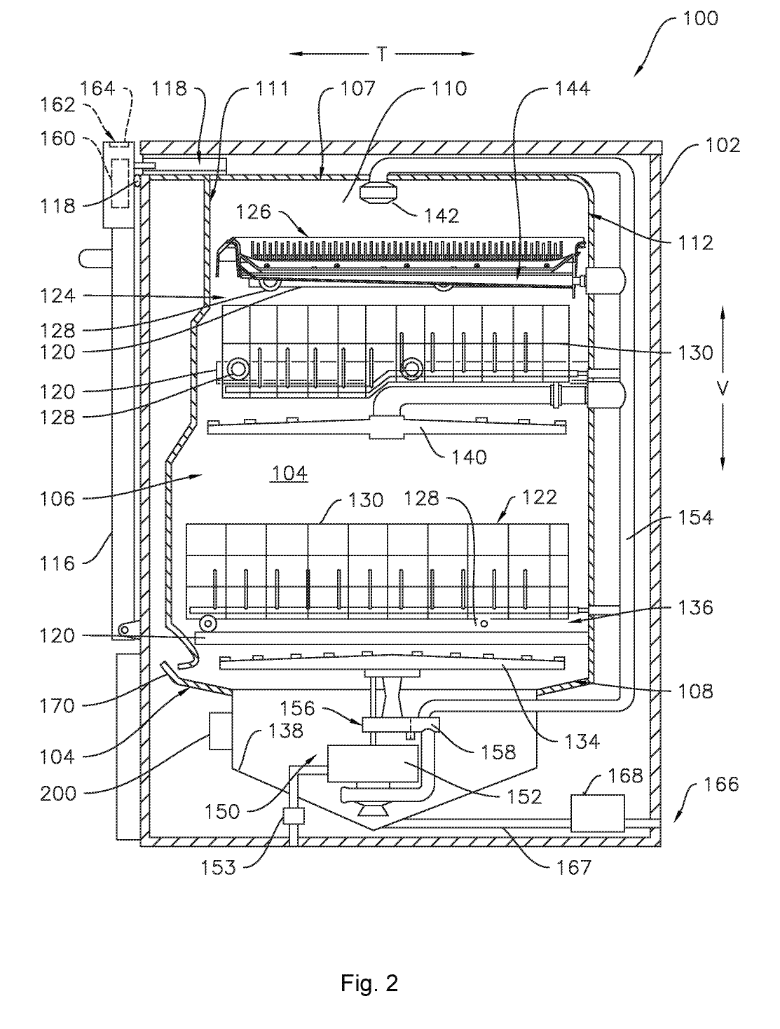

FIGS. 1 and 2 depict an exemplary dishwasher or dishwashing appliance 100 that may be configured in accordance with aspects of the present disclosure. For the particular embodiment of FIGS. 1 and 2, dishwasher 100 defines a vertical direction V, a lateral direction L, and a transverse direction T. Each of the vertical direction V, lateral direction L, and transverse direction T are mutually perpendicular to one another and form an orthogonal direction system. Dishwasher 100 includes a cabinet 102 having a tub 104 therein that defines a wash chamber 106. As shown in FIG. 2, tub 104 extends between a top 107 and a bottom 108 along the vertical direction V, between a pair of side walls 110 along the lateral direction L (only one shown in FIG. 2), and between a front side 111 and a rear side 112 along the transverse direction T.

Tub 104 includes a front opening 114 (FIG. 1) and a door 116 hinged at its bottom for movement between a normally closed vertical position (shown in FIG. 2), wherein the wash chamber 106 is sealed shut for washing operation and a horizontal open position for loading and unloading of articles from dishwasher 100. Dishwasher 100 includes a door closure mechanism or assembly 118 that is used to lock and unlock door 116 for accessing and sealing wash chamber 106.

As further shown in FIG. 2, tub side walls 110 accommodate a plurality of rack assemblies. More specifically, guide rails 120 are mounted to side walls 110 for supporting a lower rack assembly 122, a middle rack assembly 124, and an upper rack assembly 126. Upper rack assembly 126 is positioned at a top portion of wash chamber 106 above middle rack assembly 124, which is positioned above lower rack assembly 122 along the vertical direction V. Each rack assembly 122, 124, 126 is adapted for movement between an extended loading position (not shown) in which the rack is substantially positioned outside the wash chamber 106, and a retracted position (shown in FIGS. 1 and 2) in which the rack is located inside the wash chamber 106. This is facilitated, for example, by rollers 128 mounted onto rack assemblies 122, 124, 126, respectively. Although guide rails 120 and rollers 128 are illustrated herein as facilitating movement of the respective rack assemblies 122, 124, 126, it should be appreciated that any suitable sliding mechanism or member may be used according to alternative embodiments.

Some or all of the rack assemblies 122, 124, 126 are fabricated into lattice structures including a plurality of wires or elongated members 130 (for clarity of illustration, not all elongated members making up rack assemblies 122, 124, 126 are shown in FIG. 2). In this regard, rack assemblies 122, 124, 126 are generally configured for supporting articles within wash chamber 106 while allowing a flow of wash fluid to reach and impinge on those articles, e.g., during a cleaning or rinsing cycle. According to other exemplary embodiments, a silverware basket (not shown) may be removably attached to a rack assembly, e.g., lower rack assembly 122, for placement of silverware, utensils, and the like, that are otherwise too small to be accommodated by rack 122.

Dishwasher 100 further includes a plurality of spray assemblies for urging a flow of water or wash fluid onto the articles placed within wash chamber 106. More specifically, as illustrated in FIG. 2, dishwasher 100 includes a lower spray arm assembly 134 disposed in a lower region 136 of wash chamber 106 and above a sump 138 so as to rotate in relatively close proximity to lower rack assembly 122. Similarly, a mid-level spray arm assembly 140 is located in an upper region of wash chamber 106 and may be located below and in close proximity to middle rack assembly 124. In this regard, mid-level spray arm assembly 140 is generally configured for urging a flow of wash fluid up through middle rack assembly 124 and upper rack assembly 126. Additionally, an upper spray assembly 142 may be located above upper rack assembly 126 along the vertical direction V. In this manner, upper spray assembly 142 may be configured for urging and/or cascading a flow of wash fluid downward over rack assemblies 122, 124, and 126. As further illustrated in FIG. 2, upper rack assembly 126 may further define an integral spray manifold 144, which is generally configured for urging a flow of wash fluid substantially upward along the vertical direction V through upper rack assembly 126.

The various spray assemblies and manifolds described herein may be part of a fluid distribution system or fluid circulation assembly 150 for circulating water and wash fluid in tub 104. More specifically, fluid circulation assembly 150 includes a circulation pump 152 for circulating water and wash fluid (e.g., detergent, water, and/or rinse aid) in tub 104. Circulation pump 152 is located within sump 138 or within a machinery compartment located below sump 138 of tub 104. Circulation pump 152 is in fluid communication with an external water supply line (not shown) and sump 138. A water inlet valve 153 can be positioned between the external water supply line and circulation pump 152 to selectively allow water to flow from the external water supply line to circulation pump 152. Additionally or alternatively, water inlet valve 153 can be positioned between the external water supply line and sump 138 to selectively allow water to flow from the external water supply line to sump 138. Water inlet valve 153 can be selectively controlled to open to allow the flow of water into dishwasher 100 and can be selectively controlled to cease the flow of water into dishwasher 100. Further, fluid circulation assembly 150 may include one or more fluid conduits or circulation piping for directing water and/or wash fluid from circulation pump 152 to the various spray assemblies and manifolds. For example, for the embodiment depicted in FIG. 2, a primary supply conduit 154 extends from circulation pump 152, along rear 112 of tub 104 along the vertical direction V to supply wash fluid throughout wash chamber 106.

As further illustrated in FIG. 2, primary supply conduit 154 is used to supply wash fluid to one or more spray assemblies, e.g., to mid-level spray arm assembly 140 and upper spray assembly 142. However, it should be appreciated that according to alternative embodiments, any other suitable plumbing configuration may be used to supply wash fluid throughout the various spray manifolds and assemblies described herein. For example, according to another exemplary embodiment, primary supply conduit 154 could be used to provide wash fluid to mid-level spray arm assembly 140 and a dedicated secondary supply conduit (not shown) could be utilized to provide wash fluid to upper spray assembly 142. Other plumbing configurations may be used for providing wash fluid to the various spray devices and manifolds at any location within dishwasher appliance 100.

Each spray arm assembly 134, 140, 142, integral spray manifold 144, or other spray device may include an arrangement of discharge ports or orifices for directing wash fluid received from circulation pump 152 onto dishes or other articles located in wash chamber 106. The arrangement of the discharge ports, also referred to as jets, apertures, or orifices, may provide a rotational force by virtue of wash fluid flowing through the discharge ports. Alternatively, spray arm assemblies 134, 140, 142 may be motor-driven, or may operate using any other suitable drive mechanism. Spray manifolds and assemblies may also be stationary. The resultant movement of the spray arm assemblies 134, 140, 142 and the spray from fixed manifolds provides coverage of dishes and other dishwasher contents with a washing spray. Other configurations of spray assemblies may be used as well. For example, dishwasher 100 may have additional spray assemblies for cleaning silverware, for scouring casserole dishes, for spraying pots and pans, for cleaning bottles, etc.

In operation, circulation pump 152 draws wash fluid in from sump 138 and pumps it to a diverter 156, e.g., which is positioned within sump 138 of dishwasher appliance. Diverter 156 may include a diverter disk (not shown) disposed within a diverter chamber 158 for selectively distributing the wash fluid to the spray arm assemblies 134, 140, 142 and/or other spray manifolds or devices. For example, the diverter disk may have a plurality of apertures that are configured to align with one or more outlet ports (not shown) at the top of diverter chamber 158. In this manner, the diverter disk may be selectively rotated to provide wash fluid to the desired spray device.

According to an exemplary embodiment, diverter 156 is configured for selectively distributing the flow of wash fluid from circulation pump 152 to various fluid supply conduits, only some of which are illustrated in FIG. 2 for clarity. More specifically, diverter 156 may include four outlet ports (not shown) for supplying wash fluid to a first conduit for rotating lower spray arm assembly 134 in the clockwise direction, a second conduit for rotating lower spray arm assembly 134 in the counter-clockwise direction, a third conduit for spraying an auxiliary rack such as the silverware rack, and a fourth conduit for supply mid-level and/or upper spray assemblies 140, 142, e.g., such as primary supply conduit 154.

Drainage of soiled wash fluid within sump 138 may occur, for example, through drain assembly 166. In particular, wash fluid may exit sump through a drain and may flow through a drain conduit 167. A drain pump 168 may facilitate drainage of the soiled wash fluid by pumping the wash fluid to a drain line external to dishwasher 100.

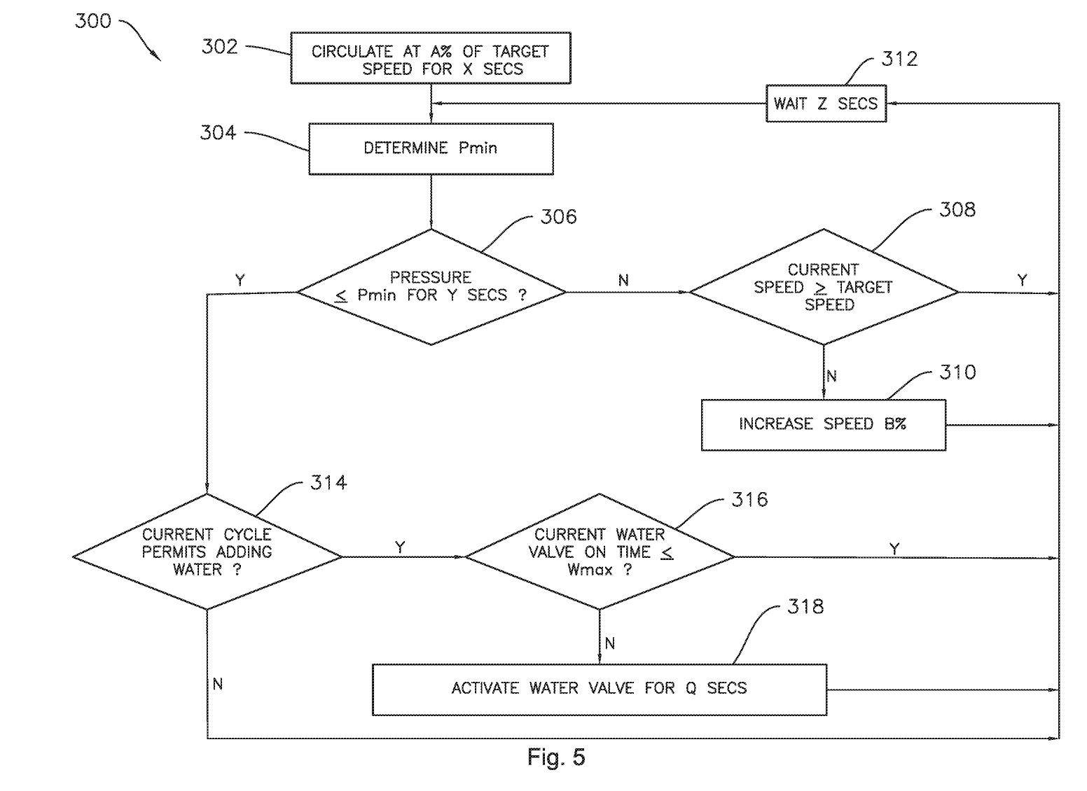

Dishwasher 100 is further equipped with a controller 160 to regulate operation of dishwasher 100. Controller 160 may include one or more memory devices and one or more microprocessors, such as general or special purpose microprocessors operable to execute programming instructions or micro-control code associated with a cleaning cycle. The memory may represent random access memory such as DRAM, or read only memory such as ROM or FLASH. In some embodiments, the processor executes programming instructions stored in memory. For example, the instructions may include a software package configured to execute a portion of the example method 300, described below with reference to FIG. 5. The memory may be a separate component from the processor or may be included onboard within the processor. Alternatively, controller 160 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 160 may be positioned in a variety of locations throughout dishwasher 100. In the illustrated embodiment, controller 160 may be located within a control panel area 162 of door 116 as shown in FIGS. 1 and 2. In such an embodiment, input/output (“I/O”) signals may be routed between the control system and various operational components of dishwasher 100 along wiring harnesses that may be routed through the bottom of door 116. Typically, the controller 160 includes a user interface panel/controls 164 through which a user may select various operational features and modes and monitor progress of dishwasher 100. In one embodiment, the user interface 164 may represent a general purpose I/O (“GPIO”) device or functional block. In one embodiment, the user interface 164 may include input components, such as one or more of a variety of electrical, mechanical or electro-mechanical input devices including rotary dials, push buttons, and touch pads. The user interface 164 may include a display component, such as a digital or analog display device designed to provide operational feedback to a user. The user interface 164 may be in communication with the controller 160 via one or more signal lines or shared communication busses. It should be noted that controllers 160 as disclosed herein are capable of and may be operable to perform any methods and associated method steps as disclosed herein. For example, in some embodiments, methods disclosed herein may be embodied in programming instructions stored in the memory and executed by the controller 160.

It should be appreciated that the invention is not limited to any particular style, model, or configuration of dishwasher 100. The exemplary embodiment depicted in FIGS. 1 and 2 is for illustrative purposes only. For example, different locations may be provided for user interface 164, different configurations may be provided for rack assemblies 122, 124, 126, different spray arm assemblies 134, 140, 142 and spray manifold configurations may be used, and other differences may be applied while remaining within the scope of the present subject matter.

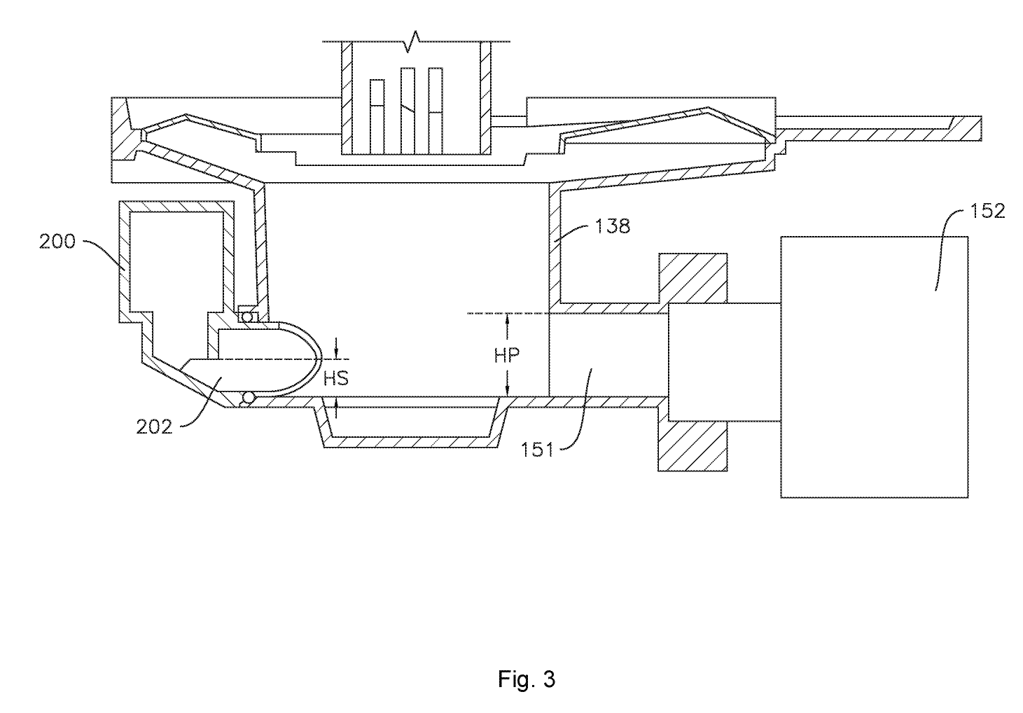

FIG. 3 provides a cross sectional view of sump 138, circulation pump 152, and a pressure sensor 200 of the dishwasher 100 of FIGS. 1 and 2. In particular, FIG. 3 illustrates the relative vertical positions of an inlet 202 of the pressure sensor 200 and an inlet 151 of the circulation pump 152. For example, as illustrated in FIG. 3, the inlet 202 of the sensor 200 may define a height HS relative to the sump 138 and the inlet 151 of the circulation pump 152 may define a height HP also relative to the sump 138. In some embodiments, the height HS of the inlet 202 of the sensor 200 may be generally the same as the height HP of the inlet 151 of the circulation pump 152. In other embodiments, the respective heights HS and HP may differ.

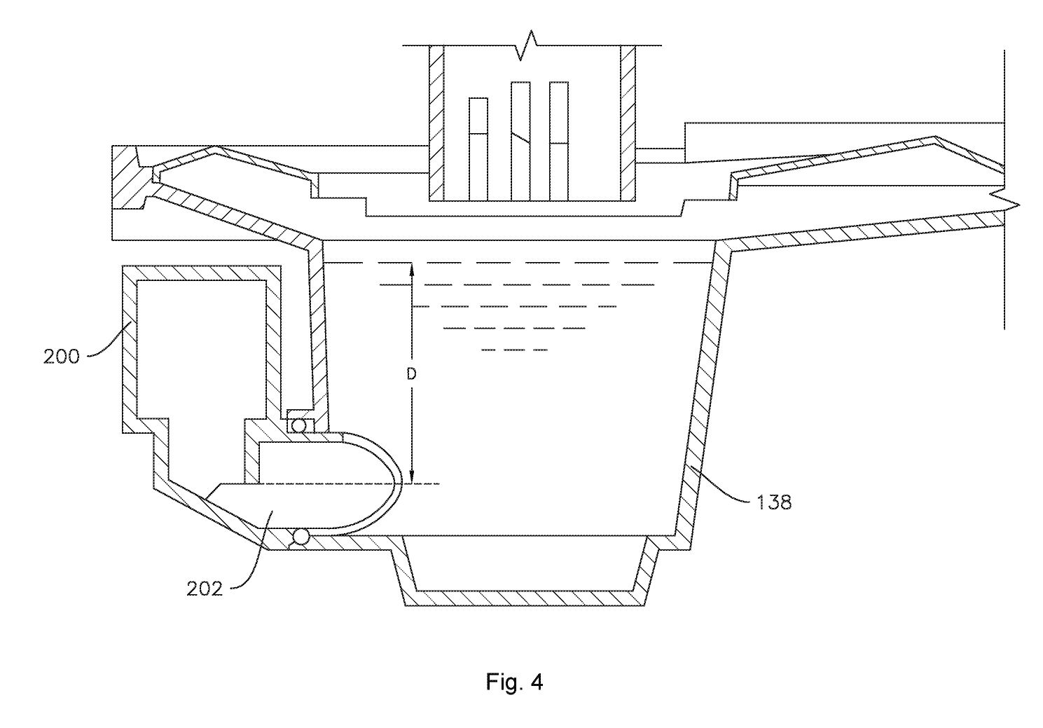

FIG. 4 provides an enlarged view of a portion of FIG. 3, in particular the pressure sensor 200 and the sump 138. The pressure sensor 200 may be operable to measure hydrostatic pressure resulting from an accumulation of water within the sump 138. Accordingly, in some exemplary aspects of the present disclosure, dishwasher 100, and in particular the controller 160 thereof, utilizes outputs from pressure sensor 200 to estimate or calculate the hydraulic head of water within the sump 138, which may be expressed in inches above the inlet 202 of the pressure sensor 200, an example of which is illustrated by liquid depth D in FIG. 4. In various embodiments, the output from the pressure sensor 200 generally correlates to the liquid depth D in the sump 138, whereby pressure values and thresholds may be used to ensure that the liquid depth D is sufficient to avoid or minimize air entrainment in the circulation pump 152. In embodiments such as the example illustrated in FIG. 3 where the respective heights HS and HP differ, such pressure values and thresholds may include an adjustment factor or offset to account for the difference in heights HS and HP. For example, as described in more detail below, an operating speed of the circulation pump 152 may be regulated according to one or more exemplary methods whereby the flow rate out of the sump 138 does not exceed the flow rate into the sump 138 from the wash chamber 106, and as a result, the liquid in the sump 138 will not be drawn down low enough to expose the inlet 151 (FIG. 3) of the circulation pump 152 to air.

Pressure sensor 200 is operatively configured to communicate the liquid depth D to controller 160 (FIG. 2) via one or more signals. Thus, pressure sensor 200 and controller 160 are communicatively coupled. The pressure sensor 200 may send signals to controller 160 as a frequency, as an analog signal, or in another suitable manner or form. Pressure sensor 200 can be any suitable type of sensor capable of sensing the liquid depth D within dishwasher 100. For example, pressure sensor 200 may be a pneumatic pressure sensor, a piezoelectric pressure sensor, or any other suitable sensor.

FIG. 5 provides a flow diagram of an exemplary method 300 of circulating fluid in a dishwasher appliance according to one or more exemplary embodiments of the present disclosure. For instance, the method 300 can be used to ensure an optimal fill level in the sump 138 of dishwasher appliance 100 as illustrated in FIGS. 1 and 2. Accordingly, the method 300 may advantageously prevent a surge of air in the dishwasher appliance 100 rather than reacting to a surge. To provide context to exemplary method 300, the reference numerals used in FIGS. 1 and 2 to describe the features of dishwasher 100 will be used below. It will be appreciated, however, that method 300 is not limited in scope to dishwasher 100 of FIGS. 1 and 2; rather, method 300 is applicable to other suitable types and models of dishwashers.

As illustrated in FIG. 5, method 300 of circulating fluid in a dishwasher appliance includes an initial step 302 of starting circulation, e.g., by operating circulation pump 152 to supply wash fluid through diverter 156 to one or more of the spray assemblies 134, 140, 142, and/or manifold 144 as described above, at a first speed less than a target speed, e.g., A % of the target speed. For example, the first speed may be about seventy-five percent (75%) of the target speed or less, such as about sixty percent (60%), such as about fifty percent (50%), such as about forty percent (40%) of the target speed or less. The first speed may advantageously be sufficiently less than the target speed to avoid creating a surge of air into the circulation pump 152. Accordingly, by starting slow and gradually increasing the speed of circulation pump in response to pressure readings from the pressure sensor 200 as described in more detail below, the exemplary method 300 may avoid or minimize surging rather than reacting to surging while also avoiding excessive water consumption. The step 302 may also include operating the circulation pump 152 at the first speed for a first amount of time, e.g., X seconds. The first amount of time may be a predetermined amount of time. For example, the first amount of time may be about seven seconds or less, such as about five seconds, such as about three seconds. The first amount of time need not be particularly long, only long enough for the circulation pump 152 to ramp up and reach a generally steady state of operation.

The method 300 may also include a step 304 of determining a first minimum pressure value (Pₘᵢₙ) based on the first speed and a position of the diverter 156. As described above, the diverter 156 may be selectively positionable in one of several, e.g., four, positions to provide fluid flow to a selected one or combination of the spray assemblies 134, 140, 142, and/or manifold 144. Accordingly, one of skill in the art will understand that the flow rate and required minimum pressure may vary depending on the position of the diverter 156. For example, supplying fluid to only one of the spray assemblies 134, 140, or 142 requires a lesser or slower flow of liquid than supplying fluid to more than one of the spray assemblies 134, 140, 142, and/or manifold 144 at the same time, and the required minimum pressure (Pₘᵢₙ) is correspondingly lower when the flow rate is lower. Additionally, where the first speed is less than the target speed, the minimum pressure (Pₘᵢₙ) to avoid air entrainment is also less than would be needed at full speed or the target speed. In some embodiments, determining the first minimum pressure value (Pₘᵢₙ) may include looking up the first speed and the position of the diverter in a lookup table. As discussed in more detail below and as shown in FIG. 5, the method 300 may include returning to step 304, e.g., to determine a second minimum pressure value. In such embodiments, subsequent minimum pressure values, e.g., a second minimum pressure value, third minimum pressure value, etc., may also be determined by looking up the current speed (e.g., a second speed, a third speed, etc.) and the position of the diverter in the lookup table

Method 300 may include, after the first amount of time has elapsed, monitoring a pressure upstream of the circulation pump 152, e.g., in the sump 138, with the pressure sensor 200. For example, the pressure may be monitored by the controller 160. Controller 160 can receive the pressure sensor output directly or indirectly from pressure sensor 200. Preferably, controller 160 receives pressure sensor outputs continuously at a predetermined interval, such as e.g., every tenth of a second, every half second, every second, etc. In this way, dishwasher 100 constantly monitors pressure upstream of the circulation pump 152, e.g., pressure in the sump 138, with the pressure sensor 200. Thus, method 300 may include a decision step at 306 of determining whether the pressure sensor output is less than or equal to the determined minimum pressure value (Pₘᵢₙ) for a second amount of time, e.g., Y seconds, consecutively. If not, e.g., when the monitored pressure continuously exceeds the minimum pressure value for the second amount of time, the method 300 may include increasing the speed of the circulation pump. For example, as illustrated in FIG. 5, the method 300 may include a decision step at 308, after determining at 306 that the pressure sensor output has not been less than or equal to Pₘᵢₙ for Y seconds consecutively, of determining whether the current speed is greater than or equal to the target speed. For example, where the first speed is less than the target speed, the method 300 may include operating the circulation pump 152 at a second speed greater than the first speed when the monitored pressure continuously exceeds the first minimum pressure value for the second amount of time. The second amount of time may be about five seconds or less, such as about four seconds, such as about three seconds, such as about two seconds or less.

As illustrated at step 310 in FIG. 5, the second speed may be greater than the first speed by a fixed, predetermined amount. For example, the step 310 may include increasing the operating speed of the circulation pump 152 by B %, where B is a set number of percentage points. For example, B may be ten percent, such that if the first speed is fifty percent of the target speed, the second speed would be sixty percent of the target speed, a third speed would be seventy percent of the target speed, or the first speed may be about forty percent of the target speed and the second speed may be about fifty percent of the target speed, etc. Also by way of example, B may be five percentage points or any other suitable increment.

Method 300 may further include operating the circulation pump at the second speed for a third amount of time, e.g., Z seconds as illustrated at 312 in FIG. 5. After the third amount of time has elapsed, e.g., after waiting Z seconds at step 312, the method 300 may then return to step 304 to determine a new Pₘᵢₙ value. For example, the method may include determining a second minimum pressure value based on the second speed and the position of the diverter after operating the circulation pump at the second speed for the third amount of time. The third amount of time may be may be a predetermined amount of time. For example, the third amount of time may be about seven seconds or less, such as about five seconds, such as about three seconds. Depending on the overall duration of the selected cycle, the method 300 may reiterate step 304 any number of times. For example, the method 300 may also include calculating a third minimum pressure value based on a third speed, a fourth minimum pressure value based on a fourth speed, etc. As noted above, the minimum pressure will generally increase as the operating speed increases. Thus, for example, where the second speed is greater than the first speed, the second minimum pressure value will also be greater than the first minimum pressure value.

As mentioned above, the method 300 may include continuously monitoring the pressure sensor output. Accordingly, the method 300 may include monitoring the pressure upstream of the circulation pump 152 with the pressure sensor 200 while operating the circulation pump 152 at the second speed. Also, method 300 may return to step 306 and determine whether the monitored pressure while operating the circulation pump at the second speed continuously exceeds the second minimum pressure value for the second amount of time. If so, or as noted at 306 in FIG. 5, if the pressure sensor output is not less than or equal to Pₘᵢₙ, and the second speed is less than the target speed at 308, e.g., if the current speed is not greater than or equal to the target speed, then the method 300 may return to step 310 and increase the speed by another increment of B %. For example, the method 300 may include operating the circulation pump 152 at a third speed greater than the second speed when the monitored pressure while operating the circulation pump 152 at the second speed continuously exceeds the second minimum pressure value for the second amount of time and when the second speed is less than the target speed.

When the decision or determination at step 308 is positive, the method 300 may continue from step 308 to steps 312 and 304, e.g., as illustrated in FIG. 5, when the current speed is greater than or equal to the target speed, the method 300 may include waiting Z seconds at 312 and returning to 304 to determine a next consecutive minimum pressure value, e.g., a third minimum pressure value, based on the current speed, e.g., the third speed, and the position of the diverter. As noted above, Z seconds may also be referred to as the third amount of time. Accordingly, in some embodiments, when the third speed is greater than or approximately equal to the target speed, the method 300 may include determining a third minimum pressure value based on the third speed and the position of the diverter after operating the circulation pump at the third speed for the third amount of time. After determining the next consecutive minimum pressure value at 304, the method 300 continues to monitor the pressure upstream of the circulation pump with the pressure sensor at step 306, e.g., when the third speed is greater than or equal to the target speed, the method 300 may include monitoring the pressure upstream of the circulation pump with the pressure sensor while operating the circulation pump at the third speed.

In some instances, at any of the above-described operating speeds, it may be determined at step 306 that the pressure sensor output is less than or equal to the determined minimum pressure value (Pmin) for the second amount of time, e.g., for Y seconds consecutively. When the monitored pressure is less than Pₘᵢₙ, e.g., the first minimum pressure value, the second minimum pressure value, etc., for the second amount of time, the method 300 may include a step 314 of determining whether the current cycle of the dishwasher permits adding water. For example, the dishwasher 100 may be selectively operable in any one of a variety of modes or cycles, such as normal wash, heavy wash, eco, etc. In some cycles, such as the eco cycle, the dishwasher appliance 100 may prioritize efficiency, e.g., by not permitting additional water to be added. In other cycles, such as the heavy wash cycle, adding water may be permitted. When the current cycle of the dishwashing appliance 100 permits adding water, the method 300 may include opening the water valve 153 for a fourth amount of time, e.g., Q seconds as noted in FIG. 5. The fourth amount of time may be less than about three seconds, such as less than about two seconds, such as less than about one and a half seconds, such as about one second or less. The method 300 may also include a limit on the total amount of water used in the cycle. For example, the method 300 may include a step 316 of determining whether a cumulative on time for the water valve 153 during the entire cycle is less than or equal to a maximum on time, Wₘₐₓ, and may activate the water valve 153 at step 318 only when the current cumulative on time is less than or equal to Wₘₐₓ at step 316. Referring to some of the above examples for illustration, if or when the monitored pressure is less than or equal to the first minimum pressure value for the second amount of time at step 306 while operating the circulation pump 152 at the first speed, and when the current cycle of the dishwashing appliance permits adding water at step 314, the method 300 may include opening the water valve 153 for the fourth amount of time at step 318 when a current cumulative water valve on time is less than a maximum water valve on time at step 316. As another example, when the monitored pressure is less than the minimum pressure value corresponding to a higher speed for the second amount of time, e.g., Y consecutive seconds at step 306, the method 300 may proceed to step 314 after more than one iteration of steps 308, 310, 312 and 304, e.g., the method 300 may include opening the water valve 153 for the fourth amount of time at step 318 when the monitored pressure while operating the circulation pump at the third speed is less than the second minimum pressure value at step 306, when a current cycle of the dishwashing appliance permits adding water at step 314, and when a current cumulative water valve on time is less than a maximum water valve on time at step 316.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method of circulating fluid in a dishwasher appliance, the dishwasher appliance comprising a circulation pump, a pressure sensor upstream of the circulation pump, and a diverter downstream of the circulation pump, the method comprising:
operating the circulation pump at a first speed less than a target speed for a first amount of time;
determining a first minimum pressure value based on the first speed and a position of the diverter;
monitoring a pressure upstream of the circulation pump with the pressure sensor;
operating the circulation pump at a second speed greater than the first speed when the monitored pressure continuously exceeds the first minimum pressure value for a second amount of time; and
determining a second minimum pressure value based on the second speed and the position of the diverter after operating the circulation pump at the second speed for a third amount of time.

2. The method of claim 1, further comprising:
monitoring the pressure upstream of the circulation pump with the pressure sensor while operating the circulation pump at the second speed; and
operating the circulation pump at a third speed greater than the second speed when the monitored pressure while operating the circulation pump at the second speed continuously exceeds the second minimum pressure value for the second amount of time and when the second speed is less than the target speed.

3. The method of claim 2, wherein the third speed is approximately equal to the target speed, further comprising:
determining a third minimum pressure value based on the third speed and the position of the diverter after operating the circulation pump at the third speed for the third amount of time; and
monitoring the pressure upstream of the circulation pump with the pressure sensor while operating the circulation pump at the third speed.

4. The method of claim 3, further comprising opening a water valve for a fourth amount of time when the monitored pressure while operating the circulation pump at the third speed is less than the second minimum pressure value, when a current cycle of the dishwashing appliance permits adding water, and when a current cumulative water valve on time is less than a maximum water valve on time.

5. The method of claim 1, further comprising opening a water valve for a fourth amount of time when the monitored pressure is less than or equal to the first minimum pressure value for the second amount of time, when a current cycle of the dishwashing appliance permits adding water, and when a current cumulative water valve on time is less than a maximum water valve on time.

6. The method of claim 5, wherein the fourth amount of time is about one and a half seconds.

7. The method of claim 1, wherein the step of determining the first minimum pressure value comprises looking up the first speed and the position of the diverter in a lookup table and the step of determining the second minimum pressure value comprises looking up the second speed and the position of the diverter in the lookup table.

8. The method of claim 1, wherein the first speed is about fifty percent of the target speed and the first amount of time is about five seconds.

9. The method of claim 1, wherein the second amount of time is about three seconds and the third amount of time is about five seconds.

10. The method of claim 1, wherein the first speed is about forty percent of the target speed and the second speed is about fifty percent of the target speed.

11. A dishwasher appliance, comprising:
a cabinet;
a tub positioned within the cabinet and defining a wash chamber for receipt of articles for washing;
one or more spray assemblies;
a circulation pump for circulating water to the one or more spray arm assemblies;
a pressure sensor upstream of the circulation pump;
a diverter downstream of the circulation pump; and
a controller communicatively coupled with the pressure sensor and the circulation pump, the controller configured to:
operate the circulation pump at a first speed less than a target speed for a first amount of time;
determine a first minimum pressure value based on the first speed and a position of the diverter;
monitor a pressure upstream of the circulation pump with the pressure sensor;
operate the circulation pump at a second speed greater than the first speed when the monitored pressure continuously exceeds the first minimum pressure value for a second amount of time; and
determine a second minimum pressure value based on the second speed and the position of the diverter after operating the circulation pump at the second speed for a third amount of time.

12. The dishwasher appliance of claim 11, wherein the controller is further configured to:
monitor the pressure upstream of the circulation pump with the pressure sensor while operating the circulation pump at the second speed; and
operate the circulation pump at a third speed greater than the second speed when the monitored pressure while operating the circulation pump at the second speed continuously exceeds the second minimum pressure value for the second amount of time and when the second speed is less than the target speed.

13. The dishwasher appliance of claim 12, wherein the third speed is approximately equal to the target speed, and the controller is further configured to:
determine a third minimum pressure value based on the third speed and the position of the diverter after operating the circulation pump at the third speed for the third amount of time; and
monitor the pressure upstream of the circulation pump with the pressure sensor while operating the circulation pump at the third speed.

14. The dishwasher appliance of claim 13, wherein the controller is further configured to open a water valve for a fourth amount of time when the monitored pressure while operating the circulation pump at the third speed is less than the second minimum pressure value, when a current cycle of the dishwashing appliance permits adding water, and when a current cumulative water valve on time is less than a maximum water valve on time.

15. The dishwasher appliance of claim 11, wherein the controller is further configured to open a water valve for a fourth amount of time when the monitored pressure is less than the first minimum pressure value, when a current cycle of the dishwashing appliance permits adding water, and when a current cumulative water valve on time is less than a maximum water valve on time.

16. The dishwasher appliance of claim 15, wherein the fourth amount of time is about one and a half seconds.

17. The dishwasher appliance of claim 11, wherein the controller is configured to determine the first minimum pressure value by looking up the first speed and the position of the diverter in a lookup table and to determine the second minimum pressure value by looking up the second speed and the position of the diverter in the lookup table.

18. The dishwasher appliance of claim 11, wherein the first speed is about fifty percent of the target speed and the first amount of time is about five seconds.

19. The dishwasher appliance of claim 11, wherein the second amount of time is about three seconds and the third amount of time is about five seconds.

20. The dishwasher appliance of claim 11, wherein the first speed is about forty percent of the target speed and the second speed is about fifty percent of the target speed.
